(19) United States
(12) Patent Application Publication
(10) Pub. No.: US 2026/0008407 A1
(43) Pub. Date: Jan. 8, 2026

(54) VEHICLE-MOUNTED ROAD SURFACE MARKING DEVICE

(71) Applicant: TOYOTA JIDOSHA KABUSHIKI KAISHA, Toyota-shi (JP)

(72) Inventors: Katsutoshi TSUZUKI, Nagoya-shi (JP); Kento NAKAZATO, Tokyo (JP)

(73) Assignee: TOYOTA JIDOSHA KABUSHIKI KAISHA, Toyota-shi (JP)

(21) Appl. No.: 19/043,870

(22) Filed: Feb. 3, 2025

(30) Foreign Application Priority Data
Jul. 4, 2024 (JP) 2024-108375

(51) Int. Cl. B60Q 1/34

(52) U.S. Cl. CPC B60Q 1/34; B60Q 2400/50

(57) ABSTRACT

A vehicle includes a towing device that is provided at a rear portion of the vehicle and tows a towed vehicle, a projection device that projects an optical image located behind the vehicle with respect to the vehicle, onto a road surface on which the vehicle travels, and a controller that controls the projection device such that a distance between a rear end portion of the optical image and the vehicle in a traveling direction of the vehicle is shortened when the towing device tows the towed vehicle as compared with when the towing device does not tow the towed vehicle.

### CROSS-REFERENCE TO RELATED APPLICATION

This application claims priority to Japanese Patent Application No. 2024-108375 filed on Jul. 4, 2024. The disclosure of the above-identified application, including the specification, drawings, and claims, is incorporated by reference herein in its entirety.

### BACKGROUND

### 1. Technical Field

The present disclosure relates to a vehicle-mounted road surface marking device.

### 2. Description of Related Art

Japanese Unexamined Patent Application Publication No. 2021-079907 (JP 2021-079907 A) discloses a vehicle-mounted road surface marking device that projects an optical image for informing a person who is located around a vehicle of a traveling direction of the vehicle onto a road surface on which the vehicle travels.

### SUMMARY

Here, it is assumed that the vehicle is configured to project an optical image located at a vehicle-rear position of the vehicle on the road surface and is configured to tow a towed vehicle using a towing device provided at a rear portion of the vehicle. In this case, there is a concern that the optical image projected from the vehicle to the vehicle-rear position may interfere with the towed vehicle. In a case where the interference occurs, there is a concern that a part or the entire of the optical image may not be projected onto the road surface, or dazzling (glare) may occur to a person who visually recognizes the optical image reflected by the towed vehicle (reflected light).

Considering the above facts, an object of the present disclosure is to provide a vehicle-mounted road surface marking device with which it is possible to reduce interference of an optical image projected onto a road surface at a vehicle-rear position of the vehicle with a towed vehicle located behind the vehicle.

A first aspect of the disclosure relates to a vehicle-mounted road surface marking device including a projection device and a controller. The projection device is provided in a vehicle including a towing device configured to tow a towed vehicle at a rear portion and projects an optical image located at a vehicle-rear position of the vehicle onto a road surface on which the vehicle travels. The controller controls the projection device such that a distance between an end portion of the optical image on a rear side and the vehicle in a traveling direction of the vehicle is shorter in a case where the towing device tows the towed vehicle as compared with a case where the towing device does not tow the towed vehicle.

In the present specification, “a distance between an end portion of the optical image on a rear side and the vehicle in a traveling direction of the vehicle is shorter in a case where the towing device tows the towed vehicle as compared with a case where the towing device does not tow the towed vehicle” includes the following aspects. For example, an aspect in which the optical image is projected onto the road surface in a case where the towing device tows the towed vehicle and the distance between the end portion of the optical image on the rear side and the vehicle in the traveling direction of the vehicle is shorter as compared with a case where the towing device does not tow the towed vehicle. Further, an aspect in which the optical image is not projected onto the road surface in a case where the towing device tows the towed vehicle is included.

The vehicle to which the vehicle-mounted road surface marking device according to the first aspect is applied includes the towing device configured to tow the towed vehicle at the rear portion. Further, the vehicle-mounted road surface marking device according to the first aspect includes the projection device that is provided in the vehicle and projects the optical image located at the vehicle-rear position of the vehicle onto the road surface on which the vehicle travels. Further, in the vehicle-mounted road surface marking device according to the first aspect, the towing device may tow the towed vehicle. The controller is provided, which controls the projection device such that a distance between the end portion of the optical image on the rear side and the vehicle in the traveling direction of the vehicle is shorter in this case as compared with a case where the towing device does not tow the towed vehicle. Therefore, interference of the optical image projected onto the road surface at the vehicle-rear position of the vehicle with the towed vehicle is reduced as compared with a case where the distance between the end portion of the optical image on the rear side and the vehicle in the traveling direction of the vehicle is constant regardless of whether or not the towing device tows the towed vehicle.

A second aspect of the disclosure relates to the vehicle-mounted road surface marking device according to the first aspect. The controller controls the projection device such that a dimension of the optical image in the traveling direction in a case where the towing device tows the towed vehicle is shorter as compared with a case where the towing device does not tow the towed vehicle.

In the second aspect, the dimension of the optical image in the traveling direction in a case where the towing device tows the towed vehicle is shorter as compared with a case where the towing device does not tow the towed vehicle. Therefore, when the vehicle tows the towed vehicle, the interference of the optical image projected onto the road surface at the vehicle-rear position of the vehicle with the towed vehicle is reduced.

A third aspect of the disclosure relates to the vehicle-mounted road surface marking device according to the second aspect. A shape of the optical image in a case where the towing device tows the towed vehicle is a shape obtained by reducing, in the traveling direction, the entirety of the optical image in a case where the towing device does not tow the towed vehicle.

In the third aspect, the shape of the optical image in a case where the towing device tows the towed vehicle is the shape obtained by reducing, in the traveling direction, the entirety of the optical image in a case where the towing device does not tow the towed vehicle. Therefore, it is possible to make the shape of the optical image in a case where the towing device tows the towed vehicle and a shape of the optical image in a case where the towing device does not tow the towed vehicle the same except for the dimension.

A fourth aspect of the disclosure relates to the vehicle-mounted road surface marking device according to the third aspect. The vehicle-mounted road surface marking device further includes an angle adjustment device that adjusts an angle of the projection device with respect to a horizontal direction in a side view of the vehicle.

With the vehicle-mounted road surface marking device according the fourth aspect, it is possible to make the shape of the optical image in a case where the towing device tows the towed vehicle the shape obtained by reducing, in the traveling direction, the entirety of the optical image in a case where the towing device does not tow the towed vehicle. Further, it is possible to change the dimension of the entirety of the optical image by adjusting the angle of the projection device.

A fifth aspect of the disclosure relates to the vehicle-mounted road surface marking device according to the second aspect. A shape of the optical image in a case where the towing device tows the towed vehicle is a shape obtained by omitting a part of the optical image in a case where the towing device does not tow the towed vehicle.

In the fifth aspect, it is possible to reduce the interference of the optical image projected onto the road surface at the vehicle-rear position of the vehicle with the towed vehicle, while a configuration of the vehicle-mounted road surface marking device is simplified.

As described above, the vehicle-mounted road surface marking device according to the present disclosure has an excellent effect that it is possible to reduce the interference of the optical image projected onto the road surface at the vehicle-rear position of the vehicle with the towed vehicle located behind the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view of a vehicle and a road including a vehicle-mounted road surface marking device according to an embodiment;

FIG. 2 is a schematic cross-sectional view of the vehicle-mounted road surface marking device as seen from a side;

FIG. 3 is a schematic rear view of a shade, which is a component of a vehicle-mounted road surface marking device;

FIG. 4 is a control block diagram of an ECU of a vehicle;

FIG. 5 is a functional block diagram of the ECU shown in FIG. 4;

FIG. 6 is a plan view similar to FIG. 1 in a case where a marking image different from FIG. 1 is projected onto a road surface;

FIG. 7 is a plan view similar to FIG. 1 when the vehicle is towing the trailer;

FIG. 8 is a flowchart showing processing executed by a CPU of the ECU;

FIG. 9 is a plan view similar to FIG. 7 of the first modification example; and

FIG. 10 is a plan view similar to FIG. 7 of the second modification example.

### DETAILED DESCRIPTION OF EMBODIMENTS

The embodiment of the vehicle-mounted road surface marking device according to the present disclosure will be described below with reference to the accompanying drawings. In addition, an arrow UP, an arrow FR, and an arrow LH in each of the drawings indicate an upper side in the vehicle vertical direction, a front side in the vehicle front-rear direction, and a left side in the vehicle width direction, respectively. When the description is made using the directions of front and rear, right and left, and up and down, the front and rear directions of the vehicle, the right and left directions of the vehicle width, and the up and down directions of the vehicle will be represented unless otherwise specified.

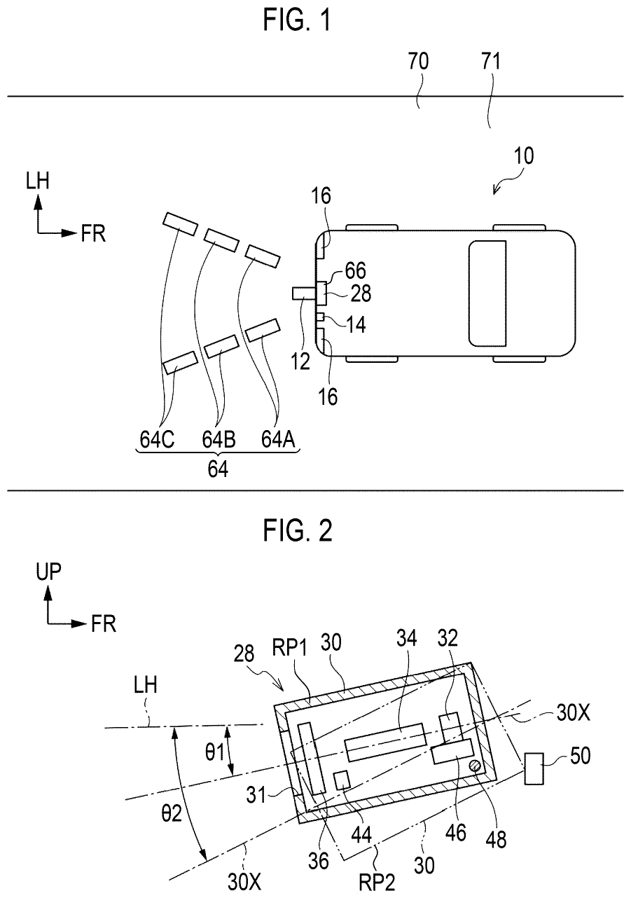

As shown in FIG. 1, a towing device 12 and a rear camera 14 are provided at a rear end portion of the vehicle 10 to which a vehicle-mounted road surface marking device 66 (hereinafter, referred to as marking device 66) of the present embodiment is applied. The towing device 12 can be connected to a connecting tool 81 provided at a front end portion of a trailer (towed vehicle) 80 (see FIG. 7) located behind the vehicle 10. The trailer 80 has a pair of right and left wheels 82. The trailer 80 does not have a self-traveling function. The rear camera 14 can image a subject located behind the vehicle 10. For example, the rear camera 14 can image the towing device 12 of the vehicle 10 and the connecting tool 81 of the trailer 80 that are connected to each other. Further, a pair of right and left back lamps 16 is provided at a rear end portion of the vehicle 10. Further, a touch panel type display 18 (see FIG. 4) is provided on an instrument panel (not shown) of the vehicle 10. The display 18 can display various images. For example, the display 18 can display an image captured by the rear camera 14.

The vehicle 10 has a blinker lever (not shown). The blinker lever is movable (rotatable) from a neutral position (initial position) to a first position below the neutral position and a second position above the neutral position. Further, the vehicle 10 has a lever position detection sensor 22 (see FIG. 4) that can detect the position of the blinker lever.

The vehicle 10 includes a shift lever (not shown). The shift lever is movable to each shift position of a P range (parking range), an R range (reverse range), an N range (neutral range), and a D range (drive range). Further, the vehicle 10 includes a shift position sensor 24 that repeatedly acquires a shift position of the shift lever at a predetermined cycle (see FIG. 4).

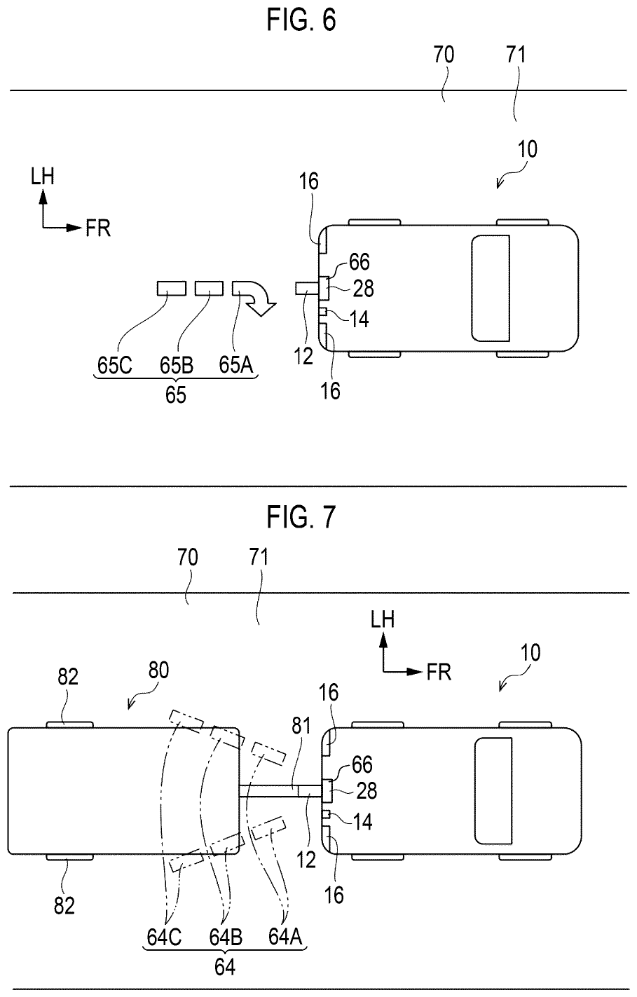

As shown in FIG. 1 and FIG. 6, a projection device 28 is provided at a rear end portion of the vehicle 10. As shown in FIG. 2, the projection device 28 includes a case 30, a light source 32, an optical system 34, a shade 36, a first electric motor 44, and a heat sink 46. The light source 32, the optical system 34, the first electric motor 44, and the heat sink 46 that are positioned inside the case 30 are fixed to the case 30. Further, an opening 31 is formed in a rear end portion of the case 30. An optical system 34 is positioned immediately behind the light source 32. Further, a shade 36 is provided inside the case 30, the shade 36 being positioned immediately behind the optical system 34 and being movable in the right-left direction with respect to the case 30.

As shown in FIG. 2, in a side view, the axial line 30X of the case 30 that passes through the opening 31, the light source 32, the optical system 34, and the shade 36 is positioned below the horizontal line HL, and the angle formed by the horizontal line HL and the axial line 30X is θ1.

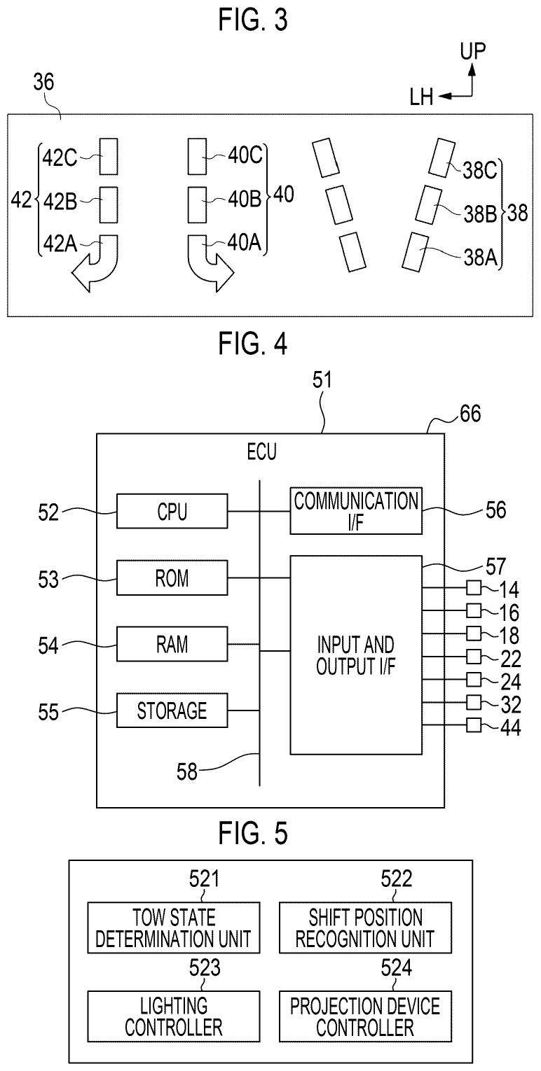

As shown in FIG. 3, the shade 36 is a metal flat plate having a rectangular front shape. The first formed hole 38, the second formed hole 40, and the third formed hole 42 are formed in the shade 36 as through holes. A first formed hole 38 formed in a right side portion of the shade 36 has two first components 38A, two second components 38B, and two third components 38C that are arranged in the vertical direction and separated from each other. The second formed hole 40 formed in the center of the shade 36 has a first component 40A, a second component 40B, and a third component 40C that are arranged in the vertical direction and separated from each other. The first component 40A has an arrow shape. The second component 40B and the third component 40C are substantially rectangular. The third formed hole 42 formed in the left portion of the shade 36 has first component 42A, a second component 42B, and a third component 42C that are arranged in the vertical direction and separated from each other. The third formed hole 42 and the second formed hole 40 are symmetrical to each other.

The shade 36 is movable to a first marking position, a second marking position on the right side of the initial position, and a third marking position on the right side of the second marking position by the driving force of the first electric motor 44. When the shade 36 is at the first opening position, the first formed hole 38 is positioned immediately behind the optical system 34, when the shade 36 is at the second opening position, the second formed hole 40 is positioned immediately behind the optical system 34, and when the shade 36 is at the third opening position, the third formed hole 42 is positioned immediately behind the optical system 34.

The heat sink 46 has a function of cooling the light source 32.

The vehicle 10 includes an electronic control unit (ECU) 51 shown in FIG. 4. The ECU 51 is configured to include a central processing unit (CPU) (controller) 52, a read only memory (ROM) 53, a random access memory (RAM) 54, a storage 55, a communication I/F (interface) 56, and an input and output I/F 57. The CPU 52, the ROM 53, the RAM 54, the storage 55, the communication I/F 56, and the input and output I/F 57 are connected to be able to communicate with each other via a bus 58. The ECU 51 can acquire information on the date and time from a timer (not shown).

The CPU 52 is a central processing unit that executes various programs or controls each unit. That is, the CPU 52 reads a program from the ROM 53 or the storage 55 and executes the program using the RAM 54 as a work area. The CPU 52 controls each configuration and performs various arithmetic processes (information processes) in accordance with a program recorded in the ROM 53 or the storage 55.

The ROM 53 stores various programs and various data. The RAM 54 temporarily stores a program or data as a work area. The storage 55 is configured by a storage device, such as a hard disk drive (HDD) or a solid state drive (SSD), and stores various programs and various data. The communication I/F 56 is an interface capable of communicating with equipment located outside the vehicle 10. The communication I/F 56 uses a communication standard, such as Bluetooth (registered trademark) or Wi-Fi (registered trademark). Further, the communication I/F 56 can communicate with an ECU different from the ECU 51 provided in the vehicle 10 via an external bus. The input and output I/F 57 is an interface for communicating with various devices. For example, the rear camera 14, the back lamp 16, the display 18, the lever position detection sensor 22, the shift position sensor 24, the light source 32, and the first electric motor 44 are connected to the input and output I/F 57.

As shown in FIG. 5, the ECU 51 has a tow state determination unit 521, a shift position recognition unit 522, a lighting controller 523, and a projection device controller 524 as a functional configuration. The tow state determination unit 521, the shift position recognition unit 522, the lighting controller 523, and the projection device controller 524 are realized by the CPU 52 reading out and executing a program stored in the ROM 53.

The tow state determination unit 521 temporarily determines whether or not the towing device 12 of the vehicle 10 and the connecting tool 81 of the trailer 80 are in the connected state by performing image processing on the image data acquired by the rear camera 14. When the towing device 12 and the connecting tool 81 are temporarily determined to be in the connected state, the tow state determination unit 521 displays a determination result image that is an image indicating that the towing device 12 and the connecting tool 81 are in the connected state, and a determination processing button image on the display 18. For example, the determination result image is a character “it is presumed that a trailer is connected”. Further, when the occupant performs the touch operation on the display 18 with respect to the displayed final processing button image, the tow state determination unit 521 makes the final determination that the towing device 12 and the connecting tool 81 are in the connected state.

The shift position recognition unit 522 recognizes the shift position based on the signal received from the shift position sensor 24.

The lighting controller 523 controls each lighting fixture provided in the vehicle 10. For example, when the shift position recognition unit 522 recognizes that the shift lever is in the R range, the lighting controller 523 turns on the right and left back lamps 16 by using the electric power of the battery provided in the vehicle 10.

The projection device controller 524 supplies the power of the battery to the projection device 28 to control the projection device 28 when a predetermined marking condition is satisfied. For example, when determination is made that the shift lever is in the R range, a first marking condition that is one of the marking conditions is satisfied. In addition, when the determination is made that the shift lever is in the D range and the determination is made that the blinker lever is at the first position or the second position, a second marking condition that is one of the marking conditions is satisfied.

When the marking condition is satisfied, the projection device controller 524 turns on the light source 32 for a predetermined time.

For example, when the first marking condition is satisfied, the projection device controller 524 controls the first electric motor 44 to position the shade 36 at the first marking position. Therefore, the light beam emitted rearward from the light source 32 and transmitted through the optical system 34 is supplied to the portion where the first formed hole 38 of the shade 36 is formed. Therefore, the light beam passing through the first formed hole 38 and the opening 31 is emitted rearward of the vehicle 10. Therefore, as shown in FIG. 1, the first marking image (optical image) 64 generated by the first formed hole 38 is projected onto the road surface 71. The first marking image 64 includes a right-and-left pair of first components 64A generated by the first component 38A, a right-and-left pair of second components 64B generated by the second component 38B, and a right-and-left pair of third components 64C generated by the third component 38C. The first marking image 64 is projected onto a portion located behind a rear end of the vehicle 10 on the road surface 71. A person who sees the first marking image 64 that is located near the road 70 and is projected onto the road surface 71 can recognize that the vehicle 10 is traveling backward.

Further, when the second marking condition is satisfied in a case where the blinker lever is in the first position, the projection device controller 524 controls the first electric motor 44 to position the shade 36 at the second marking position. Therefore, the light beam emitted from the light source 32 to the rear and transmitted through the optical system 34 is supplied to the portion where the second formed hole 40 of the shade 36 is formed. Therefore, the light beam passing through the second formed hole 40 and the opening 31 is emitted rearward of the vehicle 10. Therefore, as shown in FIG. 6, the second marking image (optical image) 65 generated by the second formed hole 40 is projected onto the road surface 71. The second marking image 65 includes a first component 65A generated by the first component 40A, a second component 65B generated by the second component 40B, and a third component 65C generated by the third component 40C. The second marking image 65 is projected onto a portion located behind a rear end of the vehicle 10 on the road surface 71. A person who sees the second marking image 65 that is located near the road 70 and is projected on the road surface 71 can recognize that the vehicle 10 is scheduled to turn right.

When the second flickering condition is satisfied in a case where the blinker lever is at the second position, the projection device controller 524 controls the first electric motor 44 to position the shade 36 at the third flickering position. Therefore, the light beam emitted from the light source 32 to the rear and transmitted through the optical system 34 is supplied to the portion where the third formed hole 42 of the shade 36 is formed. Therefore, the light beam passing through the third formed hole 42 and the opening 31 is emitted rearward of the vehicle 10. Therefore, a third marking image (not shown) is projected onto the road surface 71. The third marking image includes a first component generated by the first component 42A, a second component generated by the second component 42B, and a third component generated by the third component 42C. The third marking image is projected onto a portion located behind a rear end of the vehicle 10 on the road surface 71. A person who sees the third marking image that is located near the road 70 and is projected onto the road surface 71 can recognize that the vehicle 10 is scheduled to turn left.

Further, the projection device controller 524 does not supply the electric power of the battery to the light source 32 even when the marking condition is satisfied in a case where a predetermined towing condition is satisfied. In the present embodiment, the tow condition is satisfied when the tow state determination unit 521 makes the final determination that the towing device 12 and the connecting tool 81 are in the connected state. For example, as shown in FIG. 7, in a case where the first marking condition and the towing condition are established, the first marking image 64 is not projected onto the road surface 71 (see the imaginary line in FIG. 7).

The projection device 28 and the ECU 51 are components of the marking device 66 in the configuration described above.

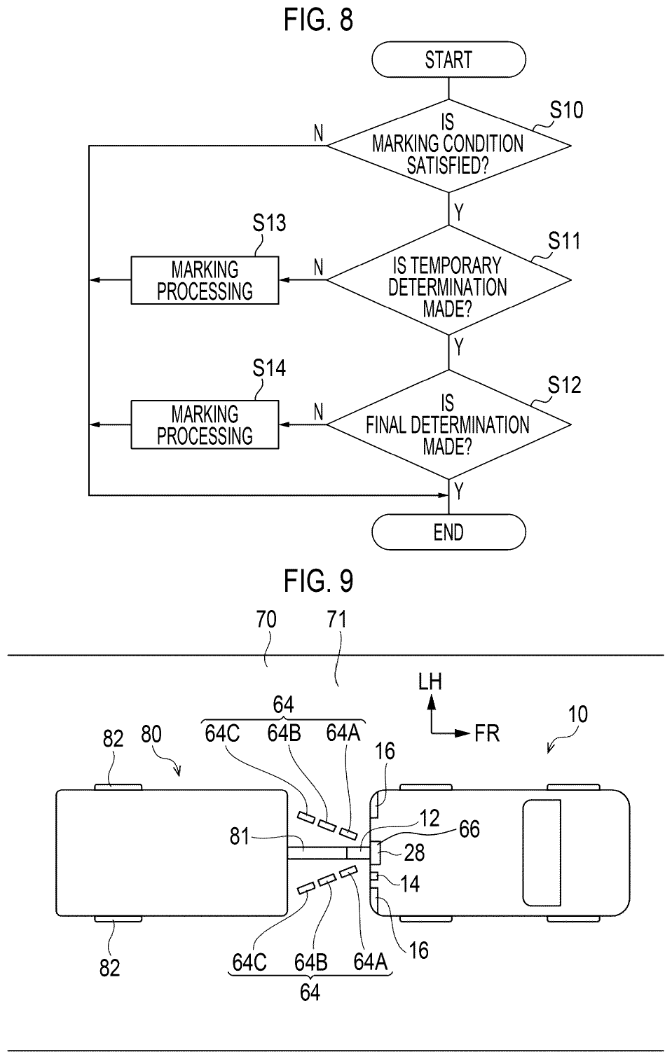

Next, processing executed by the CPU 52 of the ECU 51 will be described. The CPU 52 repeatedly executes the processing of the flowchart shown in FIG. 8 each time a predetermined time elapses.

In S10 (hereinafter, the characters of the steps are omitted), the CPU 52 determines whether or not the marking condition is satisfied.

When determination is made as Yes in S10, the CPU 52 proceeds to S11, and temporarily determines whether or not the towing device 12 of the vehicle 10 and the connecting tool 81 of the trailer 80 are in the connected state.

When determination is made as Yes in S11, the CPU 52 proceeds to S12, and determines whether or not the final determination is made that the towing device 12 and the connecting tool 81 are in the connected state.

When determination is made as Yes in S12, the CPU 52 temporarily ends the processing of the flowchart of FIG. 8. That is, in this case, the CPU 52 does not turn on the light source 32.

On the other hand, when the determination in S11 is No, the CPU 52 proceeds to S13, and executes marking processing of turning on the light source 32 and positioning the shade 36 at a predetermined position. As a result, one marking image (optical image) is projected onto the road surface 71 of the road 70.

When determination is made as No in S12, the CPU 52 proceeds to S14 to execute the marking processing.

When the processing of S13 or S14 is completed, the CPU 52 temporarily ends the processing of the flowchart of FIG. 8.

As described above, the marking device 66 of the present embodiment includes the projection device 28 that projects the optical image (first marking image 64, second marking image 65, third marking image) positioned behind the vehicle 10 onto the road surface 71 on which the vehicle 10 travels. Further, the vehicle 10 includes a towing device 12 that can tow the trailer 80. Further, the marking device 66 does not project the optical image onto the road surface 71 even when the marking condition is satisfied in a case where the towing device 12 tows the trailer 80. Therefore, there is no possibility that the optical image projected rearward from the vehicle 10 and the trailer 80 interfere with each other.

Although the vehicle-mounted road surface marking device according to the embodiment has been described above, the vehicle-mounted road surface marking device can be appropriately designed within the scope of the present disclosure.

For example, the present disclosure may be implemented in the aspect of the first modification example shown in FIGS. 2 and 9. As shown in FIG. 2, the case 30 of the first modification example is provided at a front portion of the case 30 and is rotatably supported at a rear portion of the vehicle body by a rotation center axis (angle adjustment device) 48 extending in a right-left direction. Further, the case 30 (projection device 28) is rotatable around the rotation center axis 48 by the driving force of the second electric motor (angle adjustment device) 50 provided at the rear portion of the vehicle 10. Therefore, the case 30 is rotatable between the first rotation position RP1 shown by the solid line in FIG. 2 and the second rotation position RP2 shown by the imaginary line in FIG. 2. The first rotation position RP1 is the same as the rotation position of the case 30 of the above-described embodiment. When the case 30 is at the second rotation position RP2, the axial line 30X is positioned below the horizontal line HL in the side view, and the angle formed by the horizontal line HL and the axial line 30X is θ2 greater than θ1.

Further, when the marking condition and the towing condition are satisfied, the projection device controller 524 turns on the light source 32 and controls the second electric motor 50 to set the rotation position of the case 30 to the second rotation position RP2. Therefore, as shown in FIG. 9, the optical image is projected on the road surface 71 of the road 70 on which the vehicle 10 travels in a state where the front-rear dimension is shorter than that in the above-described embodiment. That is, the distance in the traveling direction between the rear end portion of the optical image and the vehicle 10 is shorter than the distance when the towing device 12 does not tow the trailer 80. For example, in a case where the first marking condition is satisfied, the first marking image 64 is projected onto the road surface 71 as shown in FIG. 9. Note that, in this case, the distance in the traveling direction between the rear end portion of the first marking image 64 and the vehicle 10 is shorter than that in FIG. 1.

Therefore, in the first modification example, the optical image that is irradiated toward the road surface 71 is less likely to interfere with the trailer 80 as compared with a case where the distance in the traveling direction between the end portion of the optical image on the rear side and the vehicle 10 is constant regardless of whether or not the towing device 12 tows the trailer 80.

Further, the shape of the optical image projected onto the road surface 71 in the first modification example is a shape obtained by reducing the entire optical image projected onto the road surface 71 in the traveling direction in FIG. 1. Therefore, in the first modification example, the optical image (first marking image 64) formed on the road surface 71 and the shape of the optical image (first marking image 64) formed on the road surface 71 when the towing condition is not satisfied can be made the same except for the dimensions. Therefore, even in a case where the optical image on the road surface 71 has an asymmetric shape as in the second marking image 65, the optical image can be formed on the road surface 71.

Further, the marking device 66 according to the first modification example can freely change the dimensions of the entire optical image on the road surface 71 by adjusting the angle of the projection device 28.

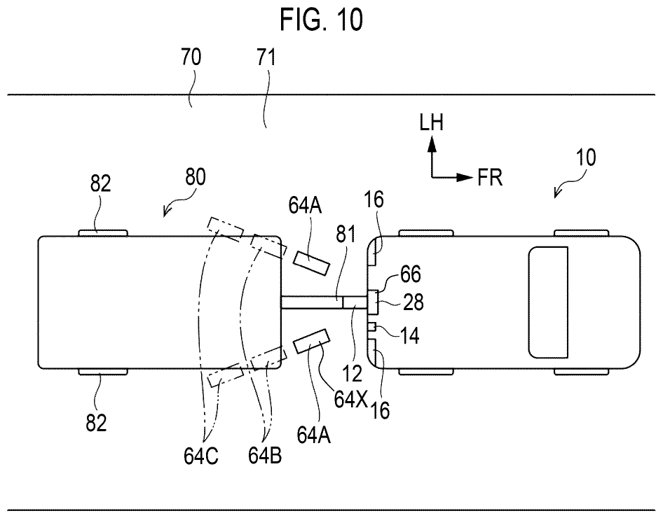

Further, the present disclosure may be implemented in an aspect of a second modification example shown in FIG. 10. For example, a first formed hole (not shown) having solely the first component 38A may be formed in the shade 36, and when the marking condition and the towing condition are satisfied, the light emitted from the light source 32 may be irradiated to a portion of the front surface of the shade 36 in which the first formed hole is provided. In this case, as shown in FIG. 10, the first marking image 64X having solely the first component 64A is projected onto the road surface 71. A distance in a traveling direction between a rear end portion of the first marking image 64X and the vehicle 10 is shorter than a distance in a traveling direction between a rear end portion of the first marking image 64 in FIG. 1 and the vehicle 10. In the second modification example, the optical image projected on the road surface 71 behind the vehicle 10 is less likely to interfere with the trailer 80 as compared with a case where the distance in the traveling direction between the rear end portion of the optical image and the vehicle 10 is constant regardless of whether or not the towing device 12 tows the trailer 80. The marking device 66 according to the second modification example may not include the rotation center axis 48 and the second electric motor 50.

When the dimensions of the entire optical image on the road surface 71 are changed by using the rotation center axis 48 and the second electric motor 50 as in the first modification example, the second electric motor 50 needs to be rotationally controlled with high precision. On the other hand, in a case where the light of the light source 32 is irradiated to the first formed hole formed in the shade 36 as in the second modification example, the molding precision of the first formed hole in the shade 36 and the control precision of the second electric motor 50 do not need to be so high. Therefore, the marking device 66 according to the second modification example can be manufactured at low cost.

In addition, a variable magnification optical system having a plurality of movable lenses may be disposed between the shade 36 and the opening 31 of the case 30. In the modification example, the magnification ratio of the variable magnification optical system is changed when the marking condition and the towing condition are satisfied, so that the same optical image as in the first modification example can be projected onto the road surface 71.

In addition, the towing condition may be satisfied when a temporary determination is made that the towing device 12 and the connecting tool 81 are in a connected state.

The projection device 28 may include a number of light sources corresponding to the number of formed holes provided in the shade 36. For example, in a case where the first formed hole 38, the second formed hole 40, and the third formed hole 42 are formed in the shade 36, the projection device 28 may include three light sources that are positioned immediately before each of the first formed hole 38, the second formed hole 40, and the third formed hole 42. In this case, solely one light source is turned on, and an optical image generated by the formed hole located immediately after the turned-on light source is projected onto the road surface 71.

The projection device 28 may include a number of light sources corresponding to the respective components of the formed holes. For example, in a case where solely the first formed hole 38 is formed in the shade 36, the projection device 28 may include three light sources that are positioned immediately before the first component 38A, the second component 38B, and the third component 38C, respectively. In this case, the optical image generated by the component corresponding to the turned-on light source is projected onto the road surface 71. For example, in a case where the meaning of one light source that is positioned immediately before the first component 38A is turned on, as shown in FIG. 10, the first marking image 64X is projected onto the road surface 71.

The shape (type) of the optical image projected on the road surface may be different from the above-described embodiment and each modification example. For example, the optical image may have solely a single part (for example, the first component 64A).

In a case where the marking condition is not satisfied and the towing condition is satisfied, the marking image may be projected onto the road surface 71.

What is claimed is:

1. A vehicle-mounted road surface marking device comprising:
a projection device that is provided in a vehicle including a towing device configured to tow a towed vehicle at a rear portion and projects an optical image located at a vehicle-rear position of the vehicle onto a road surface on which the vehicle travels; and
a controller that controls the projection device such that a distance between an end portion of the optical image on a rear side and the vehicle in a traveling direction of the vehicle is shorter in a case where the towing device tows the towed vehicle as compared with a case where the towing device does not tow the towed vehicle.

2. The vehicle-mounted road surface marking device according to claim 1, wherein the controller controls the projection device such that a dimension of the optical image in the traveling direction in a case where the towing device tows the towed vehicle is shorter as compared with a case where the towing device does not tow the towed vehicle.

3. The vehicle-mounted road surface marking device according to claim 2, wherein a shape of the optical image in a case where the towing device tows the towed vehicle is a shape obtained by reducing, in the traveling direction, an entirety of the optical image in a case where the towing device does not tow the towed vehicle.

4. The vehicle-mounted road surface marking device according to claim 3, further comprising an angle adjustment device that adjusts an angle of the projection device with respect to a horizontal direction in a side view of the vehicle.

5. The vehicle-mounted road surface marking device according to claim 2, wherein a shape of the optical image in a case where the towing device tows the towed vehicle is a shape obtained by omitting a part of the optical image in a case where the towing device does not tow the towed vehicle.
